(19) United States
(12) Patent Application Publication
(10) Pub. No.: US 2023/0281326 A1
(43) Pub. Date: Sep. 7, 2023

(54) Database Integrated Secure View

(71) Applicant: Infovia, LLC, Boise, ID (US)

(72) Inventor: Michael James Magalsky, Boise, ID (US)

(73) Assignee: Infovia, LLC, Boise, ID (US)

(21) Appl. No.: 17/686,693

(22) Filed: Mar. 4, 2022

(51) Int. Cl. G06F 21/60; G06F 21/62

(52) U.S. Cl. CPC G06F 21/604; G06F 21/6245; G06F 21/6227

(57) ABSTRACT

In aspects of database integrated secure view, a computing device maintains a database of relational data that includes identifying data and sensitive data associated with the identifying data. A schema of table structures is integrated into the database, and the table structures are populated with metapolicies that indicate the associations of the sensitive data with the identifying data. The metapolicies also indicate secure view policies that define access permissions to view one or more of the sensitive data. A query interface is implemented to query the database of the relational data for data results, and the data results are generated based at least in part on the secure view policies that define an access permission of the query to return the viewable sensitive data as the data results.

### BACKGROUND

Many organizations have multiple sources of data with inconsistent governance and/or multiple layers of data control. As with most large-scale organizations that have a multitude of data to manage, which seemingly grows exponentially, it can be a difficult challenge to organize and moderate all of the data. Adding to the data management challenges is being able to adapt to changes in security regulations and data security, particularly for personal identifiable information (PII) in industries such as healthcare, insurance, and banking, to name a few. Efforts to keep up with the regulations and the seemingly ever-expanding data in an organization may also lead to adding multiple, and sometimes redundant, layers of database management. Conventional database controllers typically have an abstraction, program layer through which all data transactions are logged and managed. Oftentimes, these multiple data abstraction and management layers are not integrated or cooperative, and can potentially lead to more abstract rather than cohesive control, management, and access to the organization's data.

### BRIEF DESCRIPTION OF THE DRAWINGS

Implementations of the techniques for database integrated secure view are described with reference to the following Figures. The same numbers may be used throughout to reference like features and components shown in the Figures:

FIG. 1 illustrates an example system for database integrated secure view in accordance with one or more implementations as described herein.

FIGS. 2a, 2b, and 2c illustrate an example system of the schema of table structures for database integrated secure view in accordance with one or more implementations as described herein.

FIG. 3 illustrates an example of a pivot for plural classes in aspects of database integrated secure view, as described herein.

FIG. 4 illustrates an example of a query initiated in a database query interface through a secure view layer of a secure view system for database integrated secure view in accordance with one or more implementations as described herein.

FIG. 5 illustrates an example cloud-based system in which aspects and features of database integrated secure view can be implemented.

FIG. 6 illustrates an example method for database integrated secure view in accordance with one or more implementations of the techniques described herein.

FIG. 7 illustrates various components of an example device that can be used to implement the techniques for a database integrated secure view as described herein.

### DETAILED DESCRIPTION

Implementations of techniques for database integrated secure view are implemented as described herein. A secure view system can be instantiated on a client server for local, premise implementation, and the secure view system is implemented within a client's current database structure. Rather than adding another new platform layer over other data management applications that may be running on the client server, the secure view system is integrated into the client database. The secure view system operates without a middleware layer through which all data transactions would have to be logged and managed, as with conventional systems. This overcomes legacy system integration, when typically each legacy database management system needs to be provisioned independently and may conflict due to the legacy systems not being setup to communicate with each other. Accordingly, the secure view system processes much faster than conventional database security systems, without the overhead of a middleware layer. Another aspect of the secure view system is instant enforcement of policy changes. Any users issuing queries through the system are immediately and transparently subject to changed policies, without the need for downstream enhancements, or changes to reporting, application code, or other systems external to the database.

Notably, organizations want to share data, but selectively and without increasing the risk of exposing sensitive information, such as the personal identifiable information of employees, clients, customers, and the like. The secure view system provides data level security managed by metapolicies, which include secure view policies, and is system agnostic and can be implemented for any type of relational database platform, whether cloud-based, on-premises, or a combination thereof. The secure view system may be implemented with ANSI-SQL (structured query language), which can execute on most any relational database, and is therefore easily deployed and migrated between multiple environments (e.g., cloud-based) and enforced simultaneously across an entire enterprise.

The secure view system is also implemented to control data access at the cell level, directly from within the existing database platform when integrated in a client system. Additionally, the secure view system provides for consistent policy enforcement of data views, and is configurable for current and future compliance, particularly in view of expanding data protection and de-identification laws. The secure view system can be implemented to maintain conformance with regulations, such as health insurance portability and accountability act (HIPAA), family educational rights and privacy act (FERPA), and general data protection regulation (GDPR). The secure view system can be implemented for data security in systems for health care providers to maintain patient privacy; global manufacturing to maintain trade secrets; insurance industry to maintain contractual obligations and client confidences; higher education to maintain student privacy; government agencies to maintain information classifications; services industries to maintain client protections; and high-tech industries to maintain intellectual property confidentiality.

In aspects of the described secure view system, relational data in a client database system can be filtered at the cell level. By defining classifications of data and roles for users, the secure view system can seamlessly provide data to all users in an organization, both internally and externally, where all of the data is filtered by consistent policies and presented with cell-level security (e.g., both rows and columns are filtered per defined policies). Downstream applications, reports, or models benefit from the consistent, streamlined provisioning approach. The secure view system also provides a seamless and consistent interface into the data. A user from one organization cannot access another organization's data without being explicitly granted access, yet a single, consistent query interface is implemented for all users. In additional aspects, the secure view system is implemented to mask or obfuscate data columns during a query based on the maintained secure view policies (e.g., such as by leveraging ANSI-SQL capabilities, in an implementation). Sensitive data, such as PII or financial information, can only be obtained or viewed when explicitly granted. Sensitive data can be securely provided to end users that may reside outside the client database domain, thus reducing the sets of data being passed between organizations' various forms.

As utilized to describe aspects of the techniques for a secure view system, a user is defined as the identity of a connection actor, usually a specific, named user or persona. A role is that of a user, where many users can associate to a role, and a user may have multiple roles simultaneously. A category is a contextual item depicting sensitive data, usually associated to a column or columns in the database. A category value is a domain value relating to a category, and a set of category values can exist to populate drop-down lists in a user interface during the maintenance of a class. A class is a set of category-value pairs that make up a policy grouping. A class element indicates a pair of category-value elements associated to the class. A policy may be defined as a role policy for a class or classes assigned to a role, or may be defined as a user policy for a class or classes assigned to a user.

In aspects of database integrated secure view as described herein, a computing device maintains a database of relational data that includes identifying data and sensitive data associated with the identifying data. Notably, the identifying data may also be sensitive data and/or the sensitive data is a subset of the identifying data. A schema of table structures is integrated into the database, and the table structures are populated with metapolicies that indicates the associations of the sensitive data with the identifying data. The schema of table structures is compatible with multiple and different types of relational database platforms and has unlimited scalability. The associations of the sensitive data with the identifying data can be represented in the schema of the table structures as label-data pairs. For example, an identifying data may be associated with one or more of the sensitive data as the label-data pairs. The metapolicies also indicate secure view policies that define access permissions to view one or more of the sensitive data. The secure view policies implement selective data share of the identifying data and the sensitive data of the relational data. Additionally, the secure view policies can implement cell-level security of cell data in the database, where the cell-level security of cell data is implemented by a combination of one or more row secure view policies and one or more column secure view policies. In implementations, the secure view policies may include singular policies that depend on one identifying data element and/or plural policies that are based on multiple identifying data elements within a class.

A query interface is implemented to query the database of the relational data for data results, and the data results are generated based at least in part on the secure view policies that define an access permission of the query to return the viewable sensitive data as the data results. In an implementation, a secure view layer can be implemented to filter the sensitive data in the database based on a combination of table filters, row filters, and/or column filters of the relational data. The query interface initiates the query through the secure view layer, and the data results of the query are returned through the secure view layer. The secure view layer leverages a database optimizer of the database to optimize the query using the schema of table structures integrated into the database.

In other aspects of database integrated secure view as described herein, a secure view system includes a schema of table structures integrated into a database of relational data. The table structures are populated with metapolicies that indicate associations of sensitive data with identifying data in the database, and the metapolicies indicate secure view policies that define access permissions to view one or more of the sensitive data. The associations of the sensitive data with the identifying data are represented by the metapolicies in the schema of the table structures as label-data pairs, and an identifying data may be associated with one or more of the sensitive data as the label-data pairs. The secure view policies implement selective data share of the identifying data and the sensitive data of the relational data. Additionally, the secure view policies implement cell-level security of cell data in the database, where the cell-level security of cell data can be implemented by a combination of a row secure view policy and a column secure view policy. The secure view system also includes a secure view layer implemented to filter the sensitive data in the database responsive to a query and based on a combination of table filters, row filters, and/or column filters of the relational data. The query generates data results based at least in part on the secure view policies applied to the sensitive data.

While features and concepts of the described techniques for a database integrated secure view can be implemented in any number of different devices, systems, environments, and/or configurations, implementations of the techniques for database integrated secure view are described in the context of the following example devices, systems, and methods.

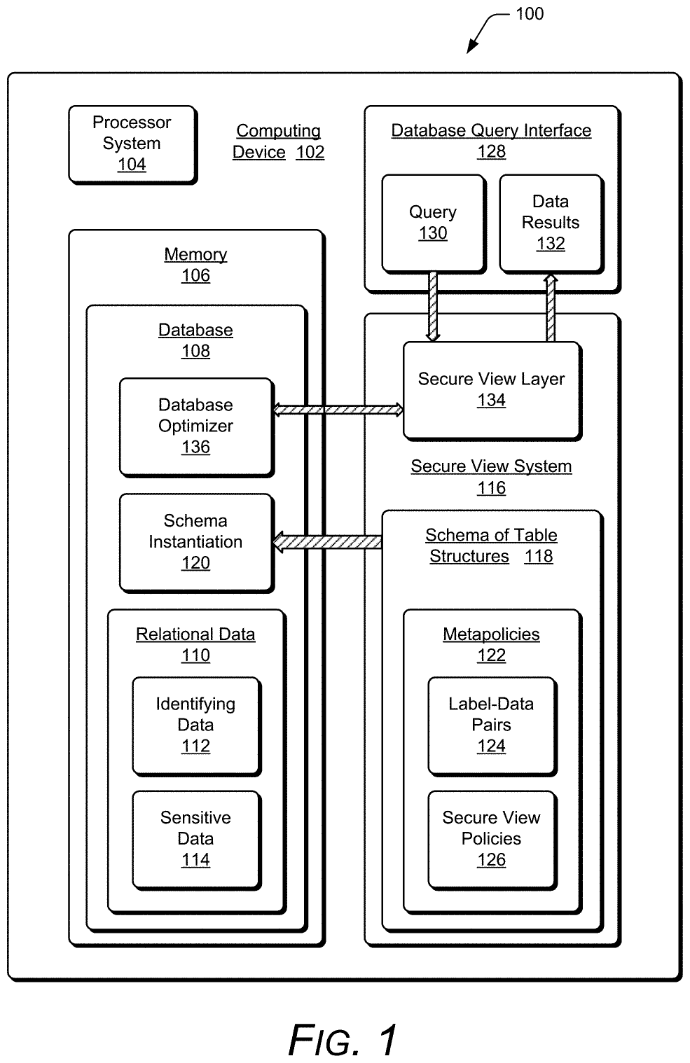

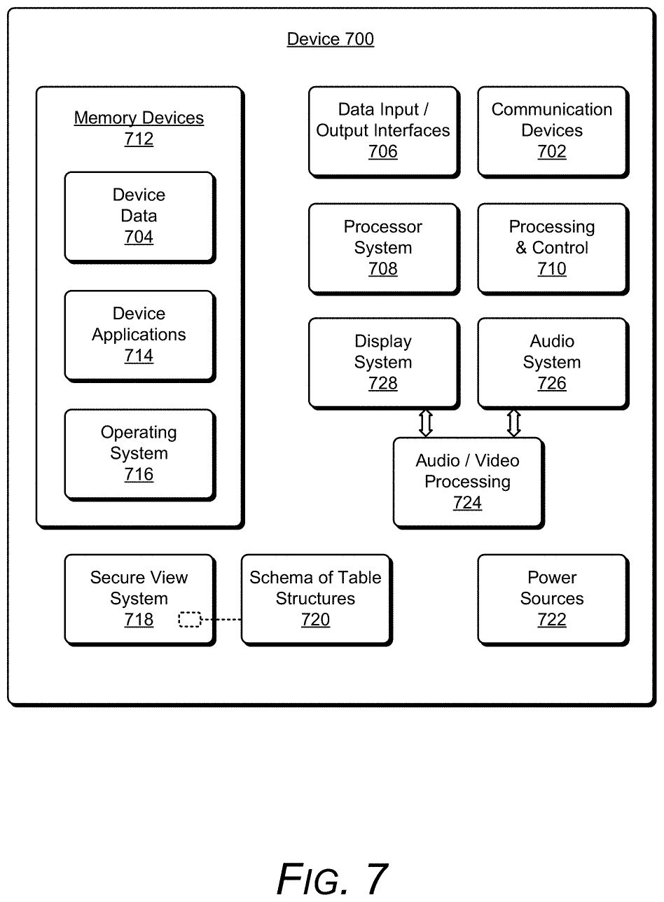

FIG. 1 illustrates an example system 100 for database integrated secure view, as described herein. The system 100 includes a computing device 102 (e.g., a processing device), which can be implemented with various components, such as a processor system 104 and memory 106, as well as any number and combination of different components as further described with reference to the example device shown in FIG. 7. The computing device 102 may be a server device that implements a database 108 stored or maintained in memory 106. In this example, the database 108 is a database of relational data 110, which includes identifying data 112 and sensitive data 114 that is associated with the identifying data. For example, an entity, such as a company or organization, may have a database 108 that maintains any type of company or organizational data. Typically, the data is relational data 110 that includes personal identifying data 112, such as a person's name and role in the organization, and includes various sensitive data 114 about the person, such as social security number (SSN), age, medical provider, insurance provider, etc. (e.g., in a healthcare example). In various database implementations, the identifying data may also be sensitive data and/or the sensitive data is a subset of the identifying data.

The computing device 102 implements a secure view system 116 in aspects of the techniques for database integrated secure view. The secure view system 116 may be implemented as any number of applications and/or modules, and may include independent processing, memory, and/or logic components functioning as a computing and/or electronic device integrated with the computing device 102. Alternatively or in addition, the secure view system 116 can be implemented in software, in hardware, or as a combination of software and hardware components. In this example, the secure view system 116 is implemented as a software application or module, such as executable software instructions (e.g., computer-executable instructions) that are executable with a processor (e.g., with the processor system 104) of the computing device 102 to implement the techniques and features described herein. As a software application or module, the secure view system 116 can be stored on computer-readable storage memory (e.g., the memory 106 of the device), or in any other suitable memory device or electronic data storage implemented system. Alternatively or in addition, the secure view system 116 may be implemented in firmware and/or at least partially in computer hardware. For example, at least part of the secure view system may be executable by a computer processor, and/or at least part of the secure view system may be implemented in logic circuitry.

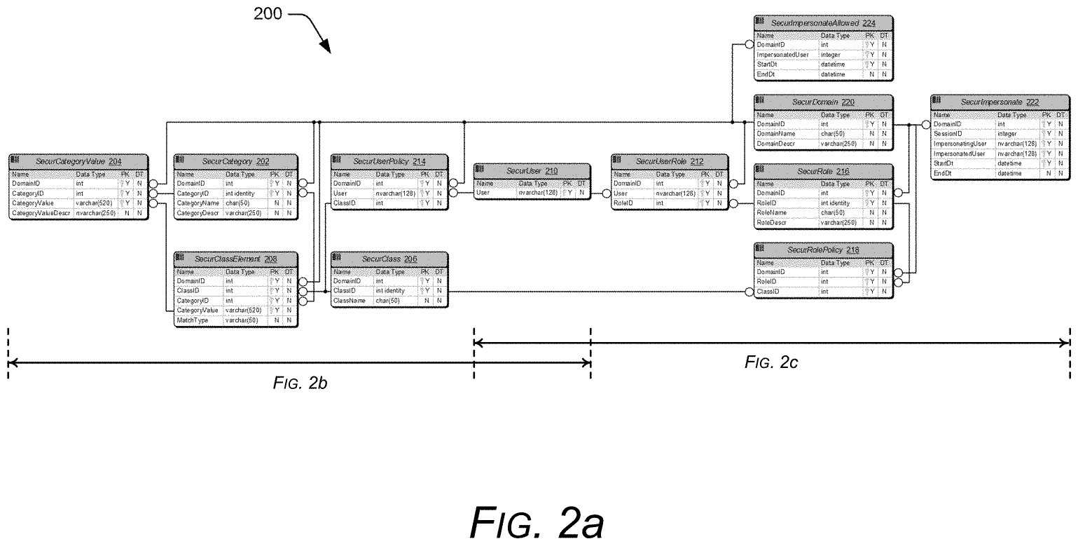

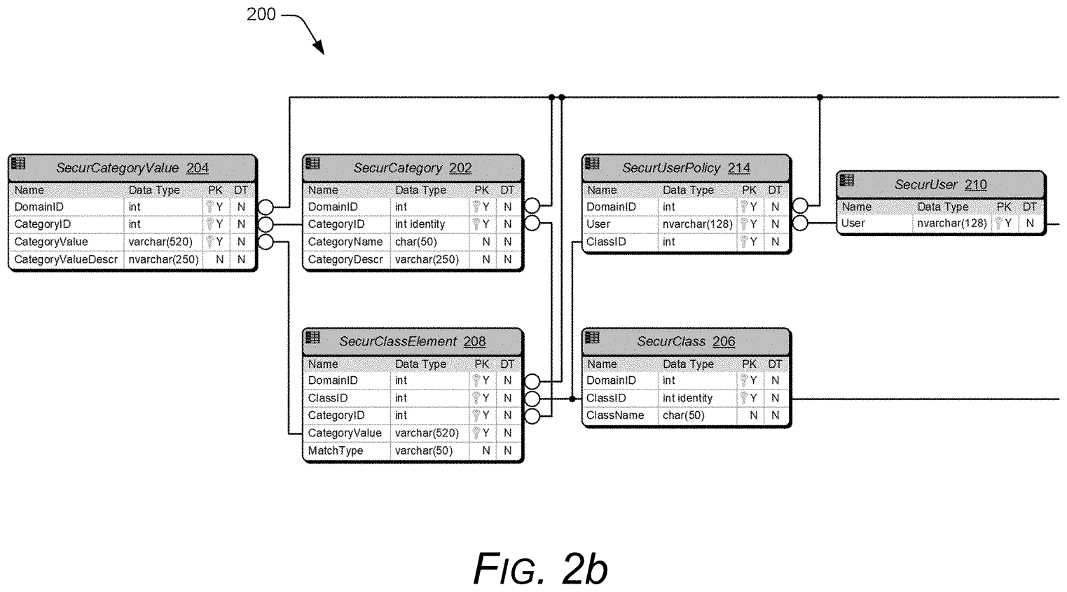

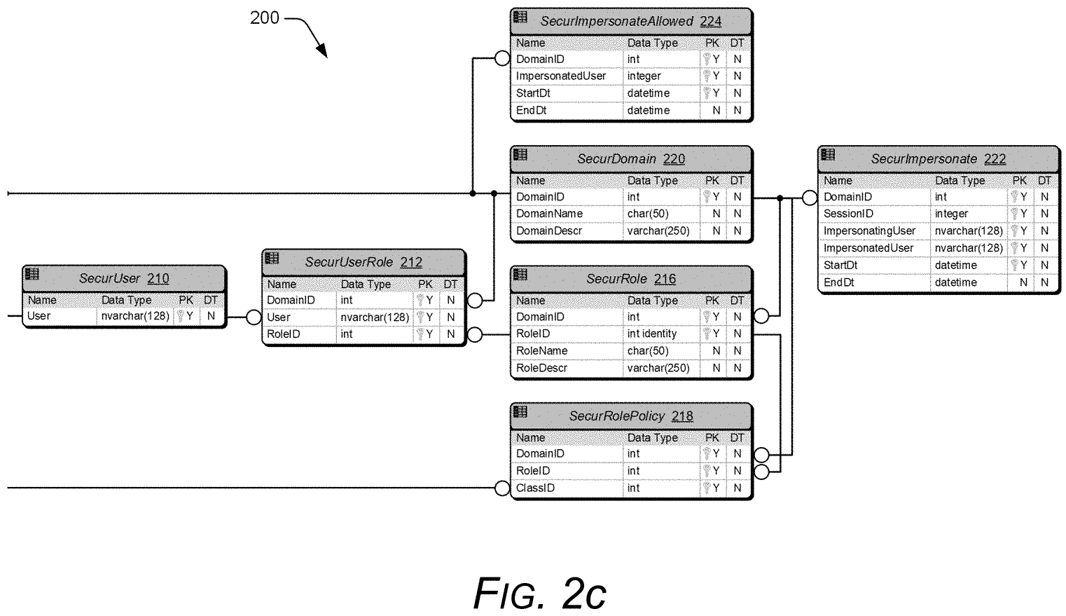

The secure view system 116 includes a schema of table structures 118 that is integrated into the database 108 as the schema instantiation 120. An example of the schema of table structures 118 is further shown and described with reference to FIGS. 2(a-c). As the schema instantiation 120 integrated into the database 108, the table structures 118 are populated with metapolicies 122 that indicate the associations of the sensitive data 114 with the identifying data 112. The associations of the sensitive data 114 with the identifying data 112 can be represented in the schema of the table structures 118 as label-data pairs 124. For example, an identifying data 112 may be associated with one or more of the sensitive data 114 as the label-data pairs 124, where column data in the client database is pivoted to setup the label-data pairs and the data associations in the table structures 118. The label-data pairs 124 provide flexibility by allowing any number of user-defined criteria to be defined and grouped together in any combination in the metapolicies 122 defined by the class and assigned in turn to the user and/or role. In alternate implementations, such as within a business intelligence (BI) tool or platform, as opposed to a database implementation, the metapolicies 122 may be exported and utilized by the BI tool or platform, using inherent capabilities such as joining, merging, filtering, and masking.

The metapolicies 122 also indicate secure view policies 126 that define access permissions to view one or more of the sensitive data 114 from the database 108. The secure view policies 126 implement selective data share of the identifying data 112 and the sensitive data 114 of the relational data 110. Additionally, the secure view policies 126 can implement cell-level security of cell data in the database, where the cell-level security of cell data is implemented by a combination of one or more row secure view policies and one or more column secure view policies. In implementations, the secure view policies 126 are made up of the label-data pairs 124 and/or made up of the associations of the label-data pairs 124 to the users and/or roles. In implementations, the secure view policies 126 may include singular policies and/or plural policies. The singular policies depend on one identifying data element and can be implemented in a filter view. The plural policies are based on multiple identifying data elements within a class, and are implemented with a pivot operation to consolidate the category-value pairs to a single row, which in turn joins to the sensitive data to create filtered views.

The computing device 102 may also implement various device applications, which may have an associated application user interface that is generated and displayable for user interaction and viewing, such as on a display screen of the computing device 102. Generally, an application user interface, or any other type of video, image, graphic, and the like is digital image content that is displayable on the display screen of the computing device. In this example system 100, the computing device implements a database query interface 128 that is associated with the database 108. A user of the computing device 102 can initiate a query 130 of the relational data 110 maintained in the database 108, and generate data results 132 that are displayed in the database query interface 128 on the display screen of the computing device 102 for user viewing.

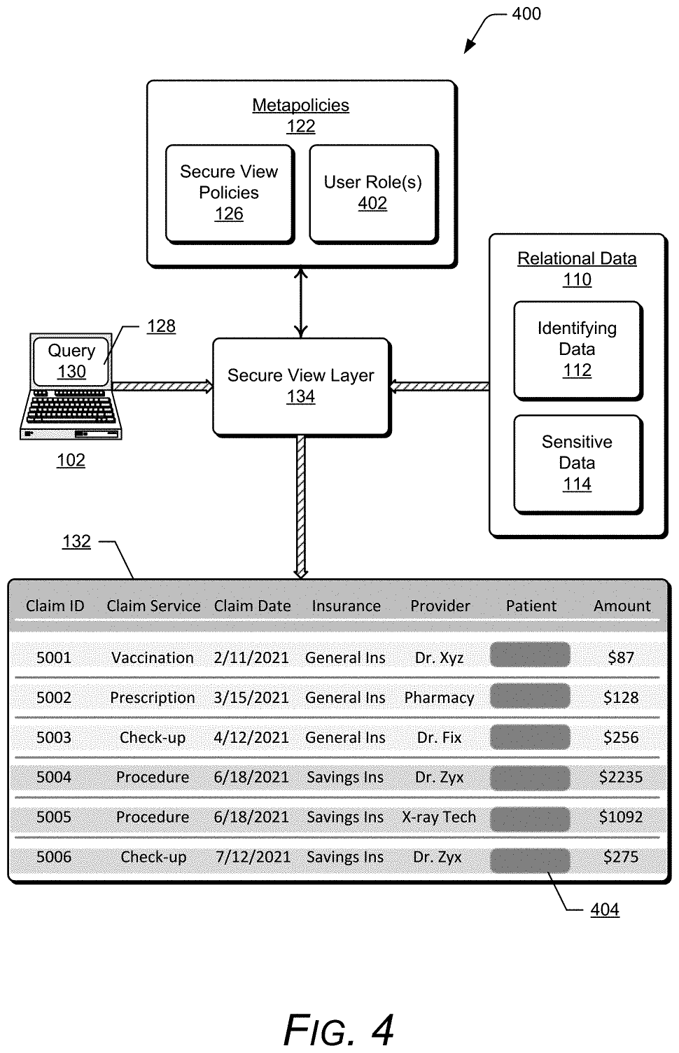

In aspects of the described database integrated secure view, the secure view system 116 is implemented with a secure view layer 134 to filter the sensitive data 114 in the database 108 based on a combination of table filters, row filters, and/or column filters of the relational data 110. As illustrated, the database query interface 128 initiates the query 130 through the secure view layer 134, and the data results 132 of the query are returned through the secure view layer from a database optimizer 136. An example of a query initiated through the secure view layer 134 of the secure view system 116 is further shown and described with reference to FIG. 4. The database optimizer 136 is generally code as part of the database 108 (e.g., client proprietary software), and the secure view layer 134 provides the database optimizer 136 with modified query data based on the metapolicies 122 and derived from the initiated query 130, which facilitates the efficiency and performance of the database optimizer.

The secure view system 116 leverages the database optimizer 136 for query performance and to render the query 130 (e.g., a SQL query) into a query plan. The database optimizer 136 determines the query plan to optimally retrieve the data results 132 from the database 108 based on the text of the query. As noted above, database optimizers are typically proprietary to the type of relational database platform, but all function similarly in that statistics are used to gather the relevant tables, structures, and contents (data). The secure view system 116 is implemented to uniquely insert the metapolicies 122 directly into the schema of table structures 118, which is instantiated on the database as the schema instantiation 120, and the database optimizer 136 can leverage the tables of the schema instantiation 120 to build the query plan. Given that the metapolicies 122 reside directly on the database 108, the database optimizer 108 can operate more efficiently (e.g., is “smarter”) and can produce results subsets that are customized for the specific query. Further, the results subsets are often smaller than the original set, allowing for faster processing of the queries, which can be returned in shorter amount of time than the unsecured, original query. Thereby, the secure view system 116 speeds the performance of the database while also producing secured result subsets filtered by the configured metapolicies. As an implementation, highly restrictive policies gain the most performance improvements because they usually reduce the input/output and CPU clock cycles required to return smaller, more restrictive data sets.

FIGS. 2(a), 2(b) and 2(c) illustrate an example system 200 of the schema of table structures 118 for database integrated secure view, as described herein. The table structures 118 include a SecurCategory table 202, which defines a set of category concepts, where categories are context concepts that define and identify the sensitive data, and the categories are the building blocks of the policies. A SecurCategoryValue table 204 defines the distinct domain values for each of the categories. A SecurClass table 206 defines a distinct set of category-value combinations that together make a specific policy when assigned to users and/or roles. It allows for modularization and reuse of policy definitions across one or more of the users and/or roles. A SecurClassElement table 208 defines the category-value data pairs that make up the class.

The table structures 118 include a SecurUser table 210 that defines all of the distinct users who may issue queries or requests for data. A SecurUserRole table 212 associates a user to a role or roles, defining the intermediate step in the user to role to class (user 4 role 4 class) assignment trio. A SecurUserPolicy table 214 defines the direct association between a user and a class, thereby creating a metapolicy without the use of a role. The purpose and/or intent is to create flexibility in how the metapolicies 122 are defined. One way is to assign a user to a role or roles (e.g., via the SecurUserRole) and in turn, associate that role to a class or classes (via SecurRolePolicy). The second flexible way is to assign a user a class or classes directly (via SecurUserPolicy). User determination logic can be platform-specific and implemented in a function that is deployed on a specific platform that includes the secure view system 116 implementation.

The table structures 118 include a SecurRole table 216 that defines the distinct list of roles. A SecurRolePolicy table 218 associates a class to a role or roles, and is a final step in creating a policy by completing the user to role to class (user 4 role 4 class) assignment trio. A SecurDomain table 220 defines the set of metadata that relate together in a multi-tenancy scenario. The default domain value is ‘1’ and usually is sufficient for most organizations until complexity or multi-tenancy dictates the need to introduce other domain values (e.g., 2, 3, etc.). All appropriate metapolicy tables contain a domain value in order to segregate subsets of policies for separate applications or security purposes. Additionally, the ability to maintain policies may be assigned at the domain level to distribute management of the metapolicies across the organization.

A SecurUserPolicy table may be used to allow specific users to associate directly to a class rather than through a user to role to class assignment. Alternatively, the SecurRolePolicy table 218 is used to associate roles to classes and the SecurUserRole table 212 is used to associate users to roles. As an exception, a SecurUserPolicy table provides a more direct approach for managing policies for certain users without role assignments being necessary. A SecurImpersonate table 222 allows for one user to emulate the security policies of another user for a period of time and/or connection scope. For example, if implemented for global impersonation, then for all connections in the database environment for the period of time defined, any connection for the impersonating user will emulate the policies of the impersonated user. Alternatively, if implemented for local impersonation, then the scope is limited to the current connection, and the impersonating user will emulate the policies of the impersonated user for only the duration of the current connection. A SecurImpersonateAllowed table 224 defines the authority for a user to be impersonated by another user for a defined period of time specified by its StartDt and EndDt datetime values.

With reference to the aspect of impersonation, this feature can be implemented when an administrator or first user allows a second user to temporarily inherit the permissions of the first user. This can be accomplished through an administrative function that populates a table in the schema of table structures 118 called ImpersonateAllowed, specifying the start and end dates, as well as a time duration, that the impersonation is valid. During that time duration only, the second user can opt to impersonate the first user for a specified time that does not overrun the allotted time duration in ImpersonateAllowed. During the impersonated time, the second user can view the policies of the first user and is allowed to view the data as if he or she is actually the first user. This impersonation feature also facilitates scenarios where generic accounts and/or service accounts are used for queries, but need to act as a specific user. In this case, the “second user” described in the example above can be replaced with a generic account identity. The impersonation feature can be connection-specific (i.e., local) or can affect all connections for the second user (i.e., global in nature). The impersonation feature is only in affect within the span of the start and end date, and within the designated time duration. A designated impersonation expires once either the ImpersonateAllowed end date time is reached or passes, or the impersonate (local or global) end date time is reached or passes.

In aspects of database integrated secure view, the secure view system 116 may also include audit tables, which can be implemented on database platforms where change tracking is not inherently available on a particular platform. The audit tables can be populated by triggers based on transactions against a parent table. In the schema of table structures 118, data inserts, updates, and deletes in a table structure are logged to a respective SecurUserPolicy audit table, a SecurUserRole audit table, a SecurRolePolicy audit table, a SecurClassElement audit table, and/or a SecurImpersonate audit table.

In aspects of the described database integrated secure view, classes can be managed by the secure view system 116. A class is defined as a grouping of category-value pairs that together make up a policy when assigned to a user and/or a role. With respect to class purpose, class definitions can serve as the building blocks of policies. A class contains all of the atomic category-value pairs to define a single, grouped set of matching criteria to identify a row or column in the data platform. Classes are reusable, and can be assigned to one or more roles and/or users to complete a policy definition. Singular classes are the simplest class and contain only elements of a single category, and as singular class, the value of a single column can evaluate the applicability of the class to the data row. Plural classes are the more complex classes, and may contain combinations of category-value pairs from multiple category definitions. These can be utilized if the value of multiple columns are to be evaluated simultaneously to determine the applicability of the class to the data row. For class assignment to roles, one or more classes can be assigned to a role, which completes the policy definition. Any user associated to that role is then allowed to see the data rows and/or columns evaluated to match the class(es) that are associated to the role. For class assignment to users, in some exception scenarios, role definitions are unnecessary and/or redundant. It is then acceptable to assign one or more classes directly to a user rather than indirectly through a role association.

In aspects of the described database integrated secure view, the secure view system 116 takes into account policy implementation. For singular policies, classes can be joined to a data set by a single column in a data table. Plural policies, which are generally more complex, can be joined to the data set by multiple columns in the data table. With reference to column-level policies, a clear text or value is the least-restrictive policy, which allows a column value to be viewed in an unmasked state. A masked text or value is a somewhat restrictive policy that allows the column value to be viewed with masking of some of its original characters. For numeric values, masking can include rounding up or down, or adding a random number within a range to the value. A no view text or value is the most-restrictive policy, which causes the column value to be eliminated from visibility and replaced with a null value in the result set.

With respect to a summarized data access, using aggregation, some policies can be implemented which restrict the detailed, row-level access to data, but rather allow for data to be displayed in aggregate to protect the identity of the population members while still reporting useful summarized data to defined roles and/or users. For population threshold enforcement, in order to further protect the identity of individuals within a population by discouraging disaggregate information identification (DII), a data set that is summarized may require elevated viewing access when a particular aggregated row of data represents a small number of individuals in the population. That small number can be defined by a population threshold parameter, which may be globally applied or applied to a specific data set depending on the legal and/or compliance requirements.

With respect to row-level policies, a methodology can be implemented as follows: (1) determine if multiple domain subsets are required (default to domain=1); (2) determine what data is sensitive based on context items; (3) define context items in business terms (e.g., as the categories); (4) collect or define the domain values for each context item (e.g., as the category values); (5) determine user domain values; (6) determine client roles; (7) determine user role mappings; (8) create classes by adding category-value combinations, where singular classes require row or column restrictions based on one or more values of a single category within a class, and plural classes are used when a combination of categories is needed to create a policy class (noting that plural classes use a pivot style view because comparison of multiple columns simultaneously within a row is necessary); (9) determine client policies (i.e., role to class mappings); (10) test and review the policies in effect for users in varying roles; (11) determine the database objects that contain definitions with sensitive category data; (12) create user secure views, leveraging the templates to “join” secure view policies for each of the database objects, depending on the use case requirements.

In aspects of the described database integrated secure view, grouped policies may contain a single category or many categories, depending on their complexity. There are three grouped keywords, assigned to class definitions in order to identify their complexity, and they are singular, plural, and range. The singular policy is defined as the simplest of the policy definitions, where singular policies contain classes which only define a single named category name in their definition. The plural policy is defined as a more complex form of policy, where knowledge of more than one category is necessary in order to evaluate a policy. The range policy is defined for the occasional need to define data classes that span a range of values. Instead of applying the client data value in a column with an equal (=) relationship, there is a “between” relationship in effect where a “min” and “max” value is specified and evaluated inclusively.

The secure view system metapolicies 122, as defined in the schema of table structures 118, are useable to determine which users can view specific category, class, and class element subsets. Reuse by virtualization extends these capabilities to leverage already-existing client data by reference to make more complex and reusable policies. By referencing this existing data, such as through a “reference” process as defined below, dynamic metapolicies can be created that morph over time, such as the database data is updated and changed by the organization that owns the database through normal, existing business processes. Often a client organization will have data within its existing systems that provides some level of relationships between users and the business entities they represent or interrelate with inside the organization. This data is useful in defining the metapolicies 122 in a supplemental way, that is, working together with the schema table structures and views, plus pre-existing client data used to develop more maintainable policies.

The secure view system 116 can implement a cascading reuse of the database views, which allows for simplified reuse of the policies by leveraging one secure view within another to filter the other in turn. For example, a product may be filtered by a metapolicy 122 and then joined to “sales” to filter “sales transactions” by showing only the sales for products that are visible to a particular user.

Generally, the client data may be maintained through an existing process and resides in the source systems and/or in identity & access management systems (e.g., directory access protocols). The data may have already been copied to the data warehouse through a regular ETL process, or alternatively, it is to be referenced inside the target database 108 by directory access protocol (e.g. LDAP) integration. The secure view system 116 also minimizes the manual process of user access management and governance, leveraging existing business processes where possible if it minimizes overhead and policy latency while maintaining the consistency. This is accomplished through the virtualization reuse, to leverage the existing client data where applicable, minimizing the burden and error-likelihood of duplicate maintenance and/or management.

The virtualization reuse can be implemented by referencing the client data that defines security concepts. In a first implementation, the reuse can be defined by reference lists, which uses the client data to virtually populate the one-dimensional objects, such as User, Role, Category, and CategoryValue, along with the two-dimensional relationship between Users and Roles, creating lists of values for Category, CategoryValue, User, Role, UserAttribute, and UserRole definitions. This uses the views: vCategory, vCategoryValue, vUser, vRole, vUserAttribute, and vUserRole. For example, a Category “Product” has domain values (i.e., CategoryValue list), for all company Products defined in a target database table called “h_Products.” Further, the Users and Roles may be defined in directory access protocol (e.g., LDAP) by an association of the role and group to the user.

In a second implementation of the virtualization reuse, the reuse can be defined by UserMap, recognizing the natural relationship between a user and other entities of the client data that those user(s) may represent. The UserMap utilizes view vUserMap, for example a User “s.smith” represented by Person “Susan Smith” with ID “1234.” The UserMap is a concept to implement by reference, and the User defined in the target database is not necessarily named exactly as a business data object would expect, so there may be mapping from one to the other. For example, if user ‘x’ represents person ‘X’ in the database, then the view vUserMap would simply return that mapping via a query that identifies that user<->person relationship within existing data. The user mapping enables definitions of more complex metapolicies 122 that leverage more natural relationships evident in existing client data, allowing to extend policies using those natural relationships to define filtering or masking functions.

In a third implementation of the virtualization reuse, the reuse can be defined by Relates, recognizing natural relationships between entities and other entities pre-defined in client data. The Relates utilizes view vRelates, for example a Person “Susan Smith” might “Teach” Student “Tommy” in her class, or a Person “Mr. Mags” might “Administrate” Teacher “Susan Smith” as her boss. Relates is a reference concept that leverages existing client data, which provides segmenting sensitive data by row and/or by column for appropriate user access, and contains directional relationships. An example is illustrated with reference to the table below, where a Student Tommy attends Third Grade at City School, and his teachers are MrMags and MrsSmith, and the data can be represented by a query in vRelates returning metadata as shown in the table:

| | Keyword | Entity1 | Entity2 |
|---|---|---|---|
| 1 | Admins | MrsJones | MrMags |
| 2 | Attends | Tommy | ThirdGrade |
| 3 | Coaches | MrMags | Ben |
| 4 | Coaches | MrMags | Tommy |
| 5 | JobType | MrMags | Basketball Coach |
| 6 | JobType | MrsSmith | Teacher |
| 7 | Location | MrsSmith | High School |
| 8 | Location | Tommy | Jr. High School |
| 9 | Teaches | MrMags | Tommy |
| 10 | Teaches | MrsSmith | Third Grade |
| 11 | Teaches | MrsSmith | Tommy |

Note that the relationship between MrsSmith and Tommy is directional, and reading the table “forward”, MrsSmith teaches Tommy, or “reverse” Tommy is taught by MrsSmith. The policy definition specifies and implements the relational direction to create filtering and masking rules. The UserMap and Relates defines the relationships between Users and business data Entities, as well as the relationships between those Entities that define data access metapolicies.

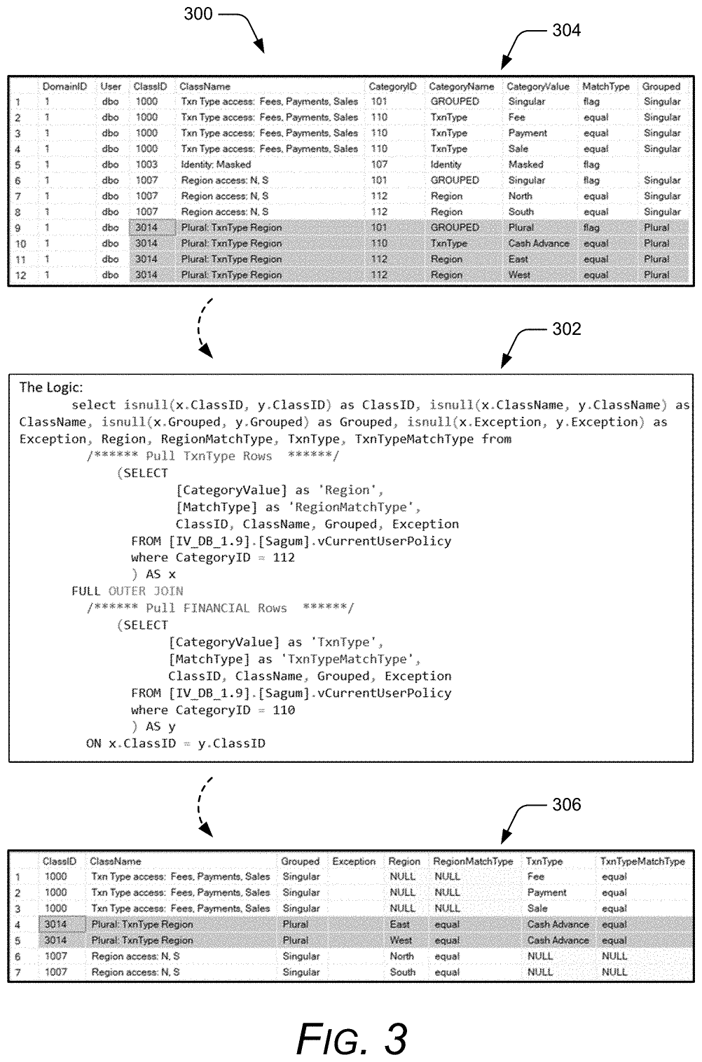

FIG. 3 illustrates an example 300 of a pivot for plural classes in aspects of database integrated secure view, as described herein. The logic 302 is applied to an example of plural metapolicy data 304, resulting in a data set 306 that is generated, which can be consumed and applied in a join to filter rows based on multiple columns.

FIG. 4 illustrates an example 400 of a query 130 initiated in the database query interface 128 and through the secure view layer 134, as described herein for database integrated secure view. The query 130 through the secure view layer 134 is within the client's own database of the relational data 110. A secure view into the database 108 is created so that a user can run a query 130, and from the secure view that combines the client's relational data 110, user role(s) 402, and the secure view policies 126 from the metapolicies 122 of the secure view system 116, generates the secure query results 132. The data results 132 of the query 130 through the secure view layer 134 are secured results of the secure view policies 126 applied to the sensitive data 114 of the relational data 110 in the database.

In this healthcare example of query results, a user may see the first results related to the General Ins. company, but not the results related to the Savings Ins. company. For example, the client data columns are pivoted to create policy in terms of label-data pairs, such as policy-provider, policy-patient, policy-insurance, etc. Further, the patient name is obfuscated at 404 in all instances of the returned secure query results. These obfuscated patient names is an example of cell-level security, based on a combination of a row secure view policy and a column secure view policy, such as by adding data row policies and data column policies together.

In aspects of the described techniques, a secure view can be built using the table structure templates, and implementing simultaneous row-level filtering and column-level masking. This allows for defining the policies that overlay the results to produce subsets of data applied to rows and columns simultaneously, as a co-existing policy enforcement and referred to herein as “cell-level security.” The resulting secure views are reusable and flexible, which simplifies the data provisioning and reduces redundancy by minimizing the data objects to be created and increasing utilization of the fewer, more flexible objects. This also reduces data management administrative time by simplifying the policies to either row or column policies, rather than the combination thereof, while allowing those policies to be paired together for flexibility and reuse. In implementations, column-level masking may take several forms, such as segregating sensitive columns into a data object identified as sensitive and then outer joining to that object; injecting identifying data through assignment of keywords to a table (and all of its rows); and/or using SQL statements with CASE statement logic for masking specific columns.

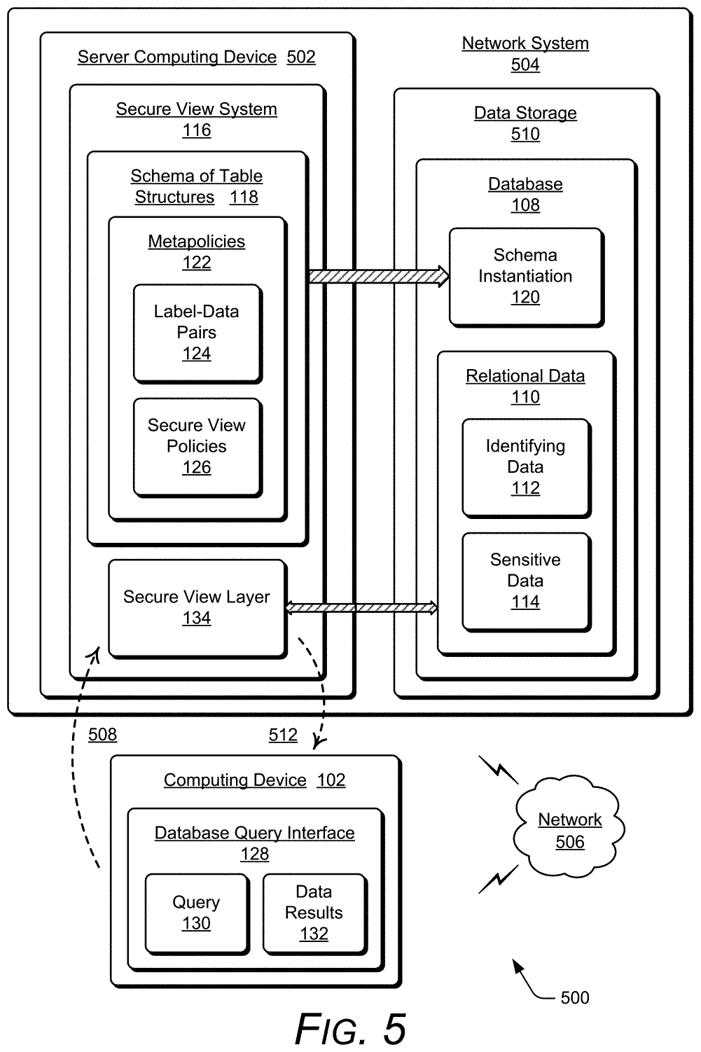

FIG. 5 illustrates an example 500 of a cloud-based system in which aspects and features of database integrated secure view can be implemented. The example 500 includes the computing device 102, such as shown and described with reference to FIG. 1. In this example 500, the computing device 102 is implemented to access and communicate with a server computing device 502 of a network system 504, such as via a communication network 506. The server computing device 502 implements the secure view system 116 as a cloud-based system, through secure API policies. The computing device 102 can upload a query 130 from the database query interface 128 to the network system 504 for processing through the secure view layer 134 of the secure view system 116. A query 130 initiated from the computing device 102 to the network system 504 may be automatically controlled by the computing device, or optionally, initiated by a user of the device. The network system 504 can receive the query 130 from the computing device 102, as indicated at 508 via the communication network 506.

Any of the devices, applications, modules, servers, and/or services described herein can communicate via the communication network 506, such as for data communication between the computing device 102 and the network system 504. The communication network 506 can be implemented to include a wired and/or a wireless network. The communication network 506 can also be implemented using any type of network topology and/or communication protocol, and can be represented or otherwise implemented as a combination of two or more networks, to include IP-based networks and/or the Internet. The communication network 506 may also include mobile operator networks that are managed by a mobile network operator and/or other network operators, such as a communication service provider, mobile phone provider, and/or Internet service provider.

In this example 500 of the cloud-based system, the network system 504 is representative of any number of cloud-based access sites that provide a service and/or from which data and information is available, such as via the Internet, for on-line and/or network-based access. The network system 504 can be accessed on-line, and includes the server computing device 502, which is representative of one or more hardware server devices (e.g., computing devices, network server devices) that may be implemented at the network system. Generally, the server computing device 502 includes memory and a processor or processing system, and may include any number and combination of different components as further described with reference to the example device shown in FIG. 7.

In this example 500 of the cloud-based system, the server computing device 502 implements the secure view system 116, such as in software, in hardware, or as a combination of software and hardware components, generally as shown and described with reference to FIGS. 1 and 2. In this example, the secure view system 116 may be implemented as a software application or modules, such as executable software instructions (e.g., computer-executable instructions) that are executable with a processing system of the server computing device 502 to implement the techniques described herein. The secure view system 116 and components can be stored on computer-readable storage media, such as any suitable memory device or on electronic data storage implemented in the server computing device 502 and/or at the network system 504.

The network system 504 may include multiple data storage, server devices, and applications, and can be implemented with various components as further described with reference to the example device shown in FIG. 7. The network system 504 also includes data storage 510 that may be implemented as any suitable memory or electronic data storage for network-based data storage. The data storage 510 is utilized at the network system 504 to maintain the database 108 of client data, such as the relational data 110 in a database environment. The data results 132 of a query 130 can then be communicated as feedback from the network system 504 to the computing device 102, as indicated at 512 via the communication network 506.

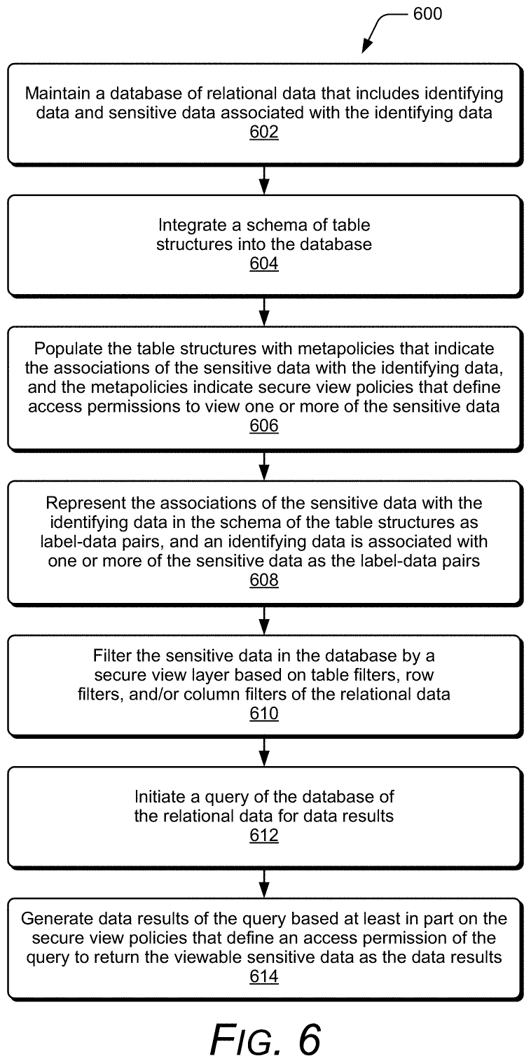

Example method 600 is described with reference to FIG. 6 in accordance with implementations for database integrated secure view. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 6 illustrates example method(s) 600 for database integrated secure view, and is described with reference to a secure view system, as described herein. The order in which the method is described is not intended to be construed as a limitation, and any number or combination of the described method operations can be performed in any order to perform a method, or an alternate method.

At 602, a database of relational data that includes identifying data and sensitive data associated with the identifying data is maintained. For example, the computing device 102 has memory 106 that maintains the database 108 of the relational data 110, which includes identifying data 112 and sensitive data 114 that is associated with the identifying data. For example, an entity, such as a company or organization, may have a database 108 that maintains any type of company or organizational data. Typically, the data is relational data 110 that includes personal identifying data 112, such as a person's name and role in the organization, and includes various sensitive data 114 about the person, such as social security number (SSN), age, medical provider, insurance provider, etc. (e.g., in a healthcare example).

At 604, a schema of table structures is integrated into the database. For example, the secure view system 116 includes a schema of table structures 118, and the table structures 118 are integrated into the database 108 as the schema instantiation 120.

At 606, the table structures are populated with metapolicies that indicate the associations of the sensitive data with the identifying data, and the metapolicies indicate secure view policies that define access permissions to view one or more of the sensitive data. For example, with the schema instantiation 120 integrated into the database 108, the table structures 118 are populated with the metapolicies 122 that indicate secure view policies 126, which define access permissions to view one or more of the sensitive data 114 from the database 108. The secure view policies 126 implement selective data share of the identifying data 112 and the sensitive data 114 of the relational data 110. Additionally, the secure view policies 126 can implement cell-level security of cell data in the database, where the cell-level security of cell data is implemented by a combination of one or more row secure view policies and one or more column secure view policies.

At 608, the associations of the sensitive data with the identifying data is represented in the schema of the table structures as label-data pairs, and an identifying data is associated with one or more of the sensitive data as the label-data pairs. For example, with the schema instantiation 120 integrated into the database 108, the table structures 118 are populated with the metapolicies 122 that indicate the associations of the sensitive data 114 with the identifying data 112. The associations of the sensitive data 114 with the identifying data 112 can be represented in the schema of the table structures 118 as label-data pairs 124. For example, an identifying data 112 may be associated with one or more of the sensitive data 114 as the label-data pairs, where column data in the client database is pivoted to setup the label-data pairs and the data associations in the table structures 118.

At 610, the sensitive data in the database is filtered by a secure view layer based on table filters, row filters, and/or column filters of the relational data. For example, the secure view system 116 is implemented with the secure view layer 134 to filter the sensitive data 114 in the database 108 based on a combination of table filters, row filters, and/or column filters of the relational data 110.

At 612, a query of the database of the relational data is queried for data results. For example, a query 130 of the database 108 of the relational data 110 is queried for data results, where the database query interface 128 initiates the query 130 through the secure view layer 134.

At 614, data results of the query are generated based at least in part on the secure view policies that define an access permission of the query to return the viewable sensitive data as the data results. For example, the data results 132 of the query 130 are generated based at least in part on the secure view policies that define an access permission of the query to return the viewable sensitive data as the data results. The data results 132 of the query are returned through the secure view layer 134 as the allowed, viewable sensitive data 114 of the relational data 110 in the database.

FIG. 7 illustrates various components of an example device 700, which can implement aspects of the techniques and features of database integrated secure view, as described herein. The example device 700 can be implemented as any of the devices described with reference to the previous FIGS. 1-6, such as any type of a computing device, processing device, server device, and/or any other type of electronic device. For example, the computing device 102 and/or the server computing device 502 may be implemented as the example device 700.

The example device 700 can include various, different communication devices 702 that enable wired and/or wireless communication of device data 704 with other devices. The device data 704 can include any of the various devices data and content that is generated, processed, determined, received, stored, and/or communicated from one computing device to another. Generally, the device data 704 can include any form of audio, video, image, graphics, and/or electronic data that is generated by applications executing on a device. The communication devices 702 can also include transceivers for cellular phone communication and/or for any type of network data communication.

The example device 700 can also include various, different types of data input/output (I/O) interfaces 706, such as data network interfaces that provide connection and/or communication links between the devices, data networks, and other devices. The I/O interfaces 706 can be used to couple the device to any type of components, peripherals, and/or accessory devices, such as a computer input device that may be integrated with the example device 700. The I/O interfaces 706 may also include data input ports via which any type of data, information, media content, communications, messages, and/or inputs can be received, such as user inputs to the device, as well as any type of audio, video, image, graphics, and/or electronic data received from any content and/or data source.

The example device 700 includes a processor system 708 of one or more processors (e.g., any of microprocessors, controllers, and the like) and/or a processor and memory system implemented as a system-on-chip (SoC) that processes computer-executable instructions. The processor system 708 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that may be implemented in connection with processing and control circuits, which are generally identified at 710. The example device 700 may also include any type of a system bus or other data and command transfer system that couples the various components within the device. A system bus can include any one or combination of different bus structures and architectures, as well as control and data lines.

The example device 700 also includes memory and/or memory devices 712 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 712 include volatile memory and non-volatile memory, fixed and removable media devices, and any suitable memory device or electronic data storage that maintains data for computing device access. The memory devices 712 can include various implementations of random-access memory (RAM), read-only memory (ROM), flash memory, and other types of storage media in various memory device configurations. The example device 700 may also include a mass storage media device.

The memory devices 712 (e.g., as computer-readable storage memory) provide data storage mechanisms, such as to store the device data 704, other types of information and/or electronic data, and various device applications 714 (e.g., software applications and/or modules). For example, an operating system 716 can be maintained as software instructions with a memory device 712 and executed by the processor system 708 as a software application. The device applications 714 may also include a device manager, such as any form of a control application, software application, signal-processing and control module, code that is specific to a particular device, a hardware abstraction layer for a particular device, and so on.

In this example, the device 700 includes a secure view system 718 that implements a schema of table structures 720, which implement various aspects of the described features and techniques described herein. The secure view system 718 can be implemented with hardware components and/or in software as one of the device applications 714, such as when the example device 700 is implemented as the computing device 102 and/or as the server computing device 502 described with reference to FIGS. 1-6. An example of the secure view system 718 and the schema of table structures 720 are the secure view system 116 and the schema of table structures 118 that are implemented by the computing device 102, such as a software application and/or as hardware components in the computing device. In implementations, the secure view system 718 may include independent processing, memory, and logic components as a computing and/or electronic device integrated with the example device 700.

The example device 700 can also include one or more power sources 722, such as when the device is implemented as a wireless device and/or mobile device. The power sources may include a charging and/or power system, and can be implemented as a flexible strip battery, a rechargeable battery, a charged super-capacitor, and/or any other type of active or passive power source. The example device 700 can also include an audio and/or video processing system 724 that generates audio data for an audio system 726 and/or generates display data for a display system 728. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 700. Alternatively, the audio system and/or the display system are external, peripheral components to the example device.

Although implementations for database integrated secure view have been described in language specific to features and/or methods, the appended claims are not necessarily limited to the specific features or methods described. Rather, the specific features and methods are disclosed as example implementations for database integrated secure view, and other equivalent features and methods are intended to be within the scope of the appended claims. Further, various different examples are described and it is to be appreciated that each described example can be implemented independently or in connection with one or more other described examples.

1. A computing device, comprising:
memory configured to maintain a database of relational data that includes identifying data and sensitive data associated with the identifying data;
a schema of table structures integrated into the database, the table structures populated with metapolicies that indicate the associations of the sensitive data with the identifying data, and the metapolicies indicating secure view policies that define access permissions to view one or more of the sensitive data; and
a query interface configured to query the database of the relational data for data results, the data results generated based at least in part on the secure view policies that define an access permission of the query to return the viewable one or more sensitive data as the data results.

2. The computing device as recited in claim 1, wherein the associations of the sensitive data with the identifying data are represented in the schema of the table structures as label-data pairs.

3. The computing device as recited in claim 2, wherein an identifying data is associated with one or more of the sensitive data as the label-data pairs.

4. The computing device as recited in claim 1, wherein a secure view layer is configured to filter the sensitive data in the database based on one or more of table filters, row filters, or column filters of the relational data.

5. The computing device as recited in claim 5, wherein the query interface is configured to initiate the query through the secure view layer, and the data results of the query are returned through the secure view layer.

6. The computing device as recited in claim 5, wherein the secure view layer leverages a database optimizer of the database to optimize the query using the schema of table structures integrated into the database.

7. The computing device as recited in claim 1, wherein the secure view policies implement selective data share of the identifying data and the sensitive data of the relational data.

8. The computing device as recited in claim 1, wherein the secure view policies implement cell-level security of cell data in the database, a cell-level security of cell data implemented by a combination of one or more row secure view policies and one or more column secure view policies.

9. The computing device as recited in claim 1, wherein the schema of table structures is compatible with multiple relational database platforms and has unlimited scalability.

10. A secure view system, comprising:
a schema of table structures integrated into a database of relational data, the table structures populated with metapolicies that indicate associations of sensitive data with identifying data in the database, and the metapolicies indicating secure view policies that define access permissions to view one or more of the sensitive data; and
a secure view layer configured to filter the sensitive data in the database responsive to a query and based on one or more of table filters, row filters, or column filters of the relational data, the query generating data results based at least in part on the secure view policies applied to the sensitive data.

11. The secure view system as recited in claim 10, wherein the associations of the sensitive data with the identifying data are represented by the metapolicies in the schema of the table structures as label-data pairs.

12. The secure view system as recited in claim 11, wherein an identifying data is associated with one or more of the sensitive data as the label-data pairs.

13. The secure view system as recited in claim 10, wherein the secure view policies implement selective data share of the identifying data and the sensitive data of the relational data.

14. The secure view system as recited in claim 10, wherein the secure view policies implement cell-level security of cell data in the database, a cell-level security of cell data implemented by a combination of one or more row secure view policies and one or more column secure view policies.

15. A method, comprising:
maintaining a database of relational data that includes identifying data and sensitive data associated with the identifying data;
integrating a schema of table structures into the database;
populating the table structures with metapolicies that indicate the associations of the sensitive data with the identifying data, and the metapolicies indicating secure view policies that define access permissions to view one or more of the sensitive data;
initiating a query of the database of the relational data for data results; and
generating data results of the query based at least in part on the secure view policies that define an access permission of the query to return the viewable one or more sensitive data as the data results.

16. The method as recited in claim 15, further comprising:
representing the associations of the sensitive data with the identifying data in the schema of the table structures as label-data pairs, and wherein an identifying data is associated with one or more of the sensitive data as the label-data pairs.

17. The method as recited in claim 15, further comprising:
filtering the sensitive data in the database by a secure view layer based on one or more of table filters, row filters, or column filters of the relational data.

18. The method as recited in claim 17, wherein the query is initiated through the secure view layer, and the data results of the query are returned through the secure view layer based at least in part on the secure view policies applied to the sensitive data.

19. The method as recited in claim 17, wherein the secure view layer leverages a database optimizer of the database to optimize the query using the schema of table structures integrated into the database.

20. The method as recited in claim 15, wherein the secure view policies implement cell-level security of cell data in the database, a cell-level security of cell data implemented by a combination of a row secure view policy and a column secure view policy.
